(19) United States
(12) Patent Application Publication
(10) Pub. No.: US 2015/0193692 A1
(43) Pub. Date: Jul. 9, 2015

(54) SYSTEMS AND METHODS OF FINDING QUANTUM BINARY OPTIMIZATION PROBLEMS

(71) Applicant: D-Wave Systems Inc., Burnaby (CA)

(72) Inventor: Robert Israel, Richmond (CA)

(21) Appl. No.: 14/540,944

(22) Filed: Nov. 13, 2014

Related U.S. Application Data
(60) Provisional application No. 61/906,220, filed on Nov. 19, 2013.
(60) Provisional application No. 61/977,458, filed on Apr. 9, 2014.

(51) Int. Cl. G06N 7/00; G06N 99/00

(52) U.S. Cl. CPC G06N 7/005; G06N 99/002

(57) ABSTRACT

Methods and systems to find quantum binary optimization problems and associated gap values employing a variety of techniques.

### BACKGROUND

### Field

The present techniques generally relate finding quantum binary optimization problems.

### Quadratic Unconstrained Binary Optimization Problems

A quadratic unconstrained binary optimization (QUBO) problem is a form of discrete optimization problem that involves finding a set of N binary variables {xᵢ} that minimizes an objective function of the form:

$$E ( {x}_{1} , … , {x}_{N} ) = {{\sum }_{i \leq j}}^{N} {Q}_{ij} {x}_{i} {x}_{j} \qquad ( 1 )$$

where Q is typically a real-valued upper triangular matrix that is characteristic of the particular problem instance being studied. QUBO problems are known in the art and applications arise in many different fields, for example machine learning, pattern matching, and statistical mechanics, to name a few.

### Linear Programming

A Linear Program (LP) is a mathematical problem to find a solution to a combined problem of optimization and solving systems of linear equations. That is, find an optimal solution of a linear objective function subject to linear constraints expressed as equalities and inequalities. The optimal value can be a minima or maxima. This can have the form:

Optimize: cx

Subject to: Ax=b

Subject to: x≧0 (2)

Where c and b are vectors of coefficients, A is a matrix defining the linear system of equalities, and x is the vector of variables to be determined. The product cx is the objective function to be minimized or maximized. The Equations (2) can be expressed as a series of equalities and inequalities. Linear programming may be used many problems including: planning, routing, scheduling, assignment, and portfolio optimization.

### Satisfiability Problems

Satisfiability problems (SAT) are a set of decision problems for determining if there a set of values that be that satisfy a Boolean formula. That is, does the set of values for a set of variables, called a truth assignment, lead to the Boolean formula to evaluate to true. The Boolean formula is made from a series of literals: a Boolean variable or its negation. These literals are then joined into clauses and then the Boolean formula using operators. The form of the clauses and the operator used define the subclass of the problems. For example, if there are three literals in the clauses, then the problem is in 3SAT. If the literals are joined by OR operators and the clauses by AND operators the problem is CNF-3SAT. SAT was the first known NP-complete problem. Satisfiability problems arise in industrial applications, computational problems, and the like.

### Optimization Problems

The object of optimization problem is finding the best solution amongst a set of possible solutions. Compare these problems to decision problems where the object is to arrive at a yes or no answer.

### Constraint Satisfaction Problems

Constraint satisfaction problems (CSPs) are problems defined as a set of objects whose state must satisfy a number of constraints. The constraints are expressed over a solved by finding the configuration of variables satisfies the constraints. Constraint satisfaction problems may be solved combinatorial searches, heuristics, combinations of these, and the like.

### BRIEF SUMMARY

Methods and systems to find quantum binary optimization problems and associated gap values employing a variety of techniques.

A method of increasing computational efficiency of a quantum processor based computational system may be summarized as including receiving a relation and a graph; initializing a probe set; initializing a lower bound; for a number of cycles until an end condition is reached: iterating over an expansion of the probe set and a configuration of helper variables to solve a first linear program for a quadratic unconstrained binary optimization (QUBO) problem and an energy gap which corresponds to the QUBO problem; selecting an expanded probe set with a sufficiently small number of solutions for which the energy gap exceeds the lower bound; determining whether there are no solutions for which the energy gap exceeds the lower bound, in response to determining that there are no solutions for which the energy gap exceeds the lower bound, backtracking in the probe set; selecting a respective configuration of helper variables at random based on a probability proportional to a difference between the energy gap and the lower bound; solving a second linear program to determine a first new lower bound; in response to the first new lower bound exceeding the lower bound, setting the lower bound equal to the first new lower bound; performing a local search to determine a second new lower bound; and in response to the second new lower bound exceeding the lower bound, setting the lower bound equal to the second new lower bound.

The method may further include repeating the iterating, selecting, determining, backtracking, selecting, solving, setting and performing until the earliest of: the lower bound exceeds a determined threshold, a defined time has elapsed, or a defined number of cycles has been performed.

A system to increase computational efficiency of a quantum processor based computational system may be summarized as including at least one processor; and at least one nontransitory processor-readable medium communicatively coupled to the at least one processor and which stores at least one of processor-executable instructions or data, which when executed by the at least one processor causes the at least one processor to: initialize a probe set; initialize a lower bound; for a number of cycles until an end condition is reached: iterate over an expansion of the probe set and a configuration of helper variables to solve a first linear program for a quadratic unconstrained binary optimization (QUBO) problem and an energy gap which corresponds to the QUBO problem; select an expanded probe set with a sufficiently small number of solutions for which the energy gap exceeds the lower bound; determine whether there are no solutions for which the energy gap exceeds the lower bound, in response to a determination that there are no solutions for which the energy gap exceeds the lower bound, backtrack in the probe set; select a respective configuration of helper variables at random based on a probability proportional to a difference between the energy gap and the lower bound; solve a second linear program to determine a first new lower bound; in response to the first new lower bound exceeding the lower bound, set the lower bound equal to the first new lower bound; perform a local search to determine a second new lower bound; and in response to the second new lower bound exceeding the lower bound, set the lower bound equal to the second new lower bound. The at least one processor may repeat the cycles until the earliest of: the lower bound exceeds a determined threshold, a defined time has elapsed, or a defined number of cycles has been performed.

A method of increasing computational efficiency of a quantum processor based computational system may be summarized as described and shown in the specification and drawings.

A system to increase computational efficiency of a quantum processor based computational system may be summarized as described and shown in the specification and drawings.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a flow-diagram showing a method for finding a quadratic binary optimization problem (QUBO) and associated gap values.

FIG. 2 is a flow-diagram showing a method for searching for QUBOs and associated gap values.

FIG. 3 is a flow-diagram for testing the search results and as needed backtracking.

FIG. 4 is a flow-diagram for accepting a solution from the search and looking for improved solutions.

FIG. 5 is a flow-diagram for looking for still improved solutions by local search.

FIG. 6 is a block of pseudocode the flow diagrams in the preceding Figures.

FIG. 7 is a flow-diagram for delayed constraint generation when solving linear programming equations.

FIG. 8 shows to examples of constraints, the associated relations, and the complement to the relations.

FIG. 9 is a schematic diagram of an exemplary hybrid computing system including a digital processor and quantum process that may be used to perform processing tasks described in the present disclosure.

FIG. 10 is a schematic diagram of a portion of a superconducting quantum processor designed for quantum annealing and/or adiabatic quantum computation to implement tasks described in the present disclosure.

### DETAILED DESCRIPTION

In the following description, some specific details are included to provide a thorough understanding of various disclosed embodiments. One skilled in the relevant art, however, will recognize that embodiments may be practiced without one or more of these specific details, or with other methods, components, materials, etc. In other instances, well-known structures including microprocessors and drive circuitry have not been shown or described in detail to avoid unnecessarily obscuring descriptions of the embodiments of the present methods.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment,” or “an embodiment,” or “another embodiment” means that a particular referent feature, structure, or characteristic described in connection with the embodiment is included in at least one embodiment. Thus, the appearances of the phrases “in one embodiment,” or “in an embodiment,” or “another embodiment” in various places throughout this specification are not necessarily all referring to the same embodiment. Furthermore, the particular features, structures, or characteristics may be combined in any suitable manner in one or more embodiments.

It should be noted that, as used in this specification and the appended claims, the singular forms “a,” “an,” and “the” include plural referents unless the content clearly dictates otherwise. Thus, for example, reference to a problem-solving system including “a processor” includes a single processor, or two or more processors. It should also be noted that the term “or” is generally employed in its sense including “and/or” unless the content clearly dictates otherwise.

The headings provided herein are for convenience only and do not interpret the scope or meaning of the embodiments.

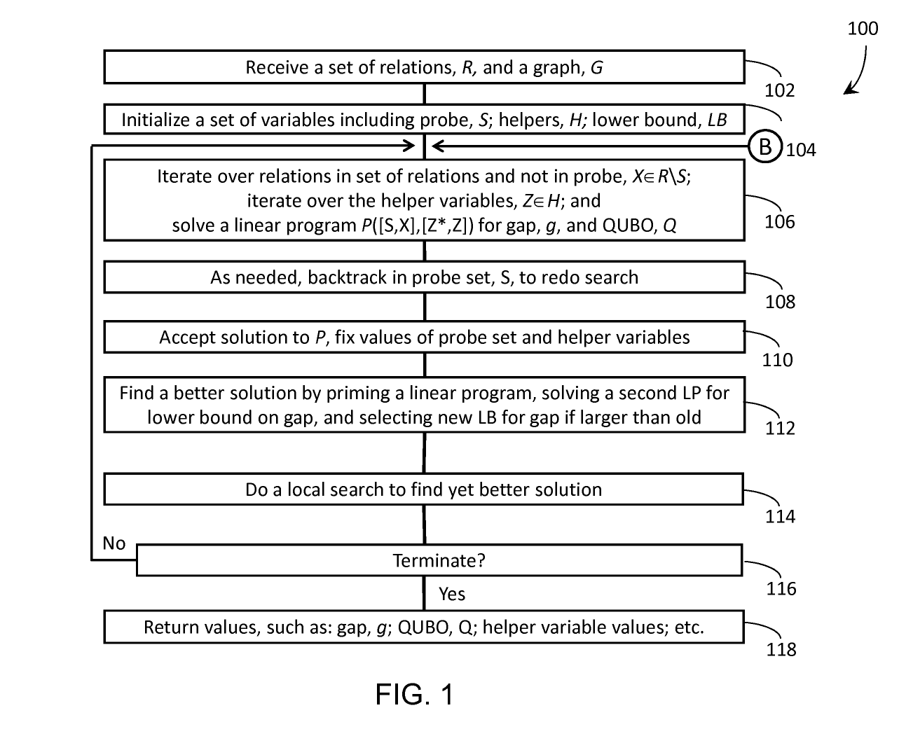

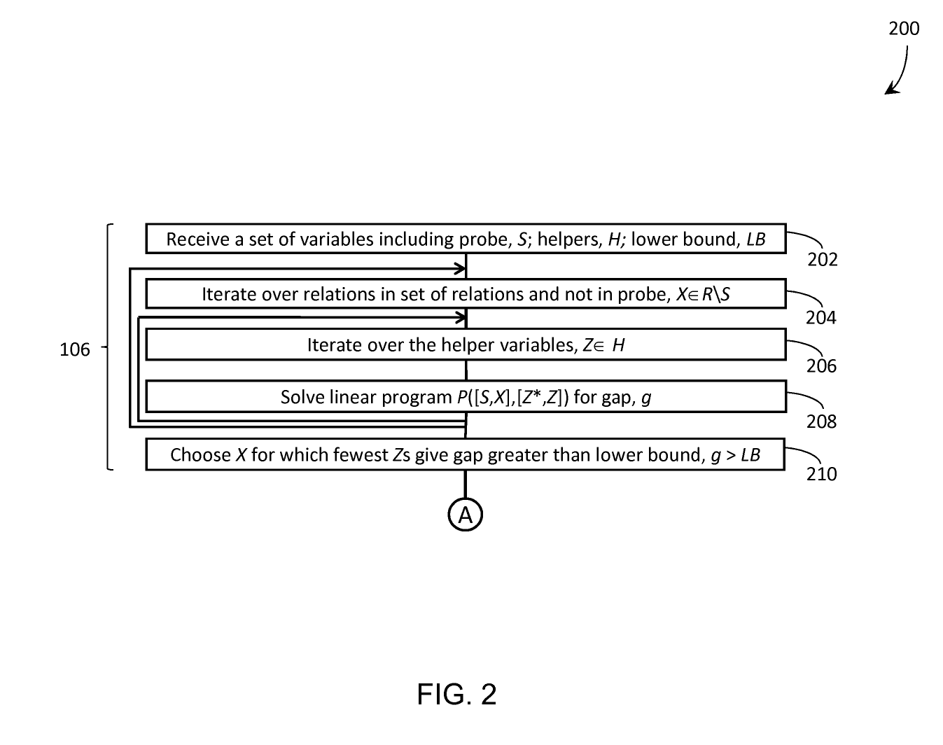

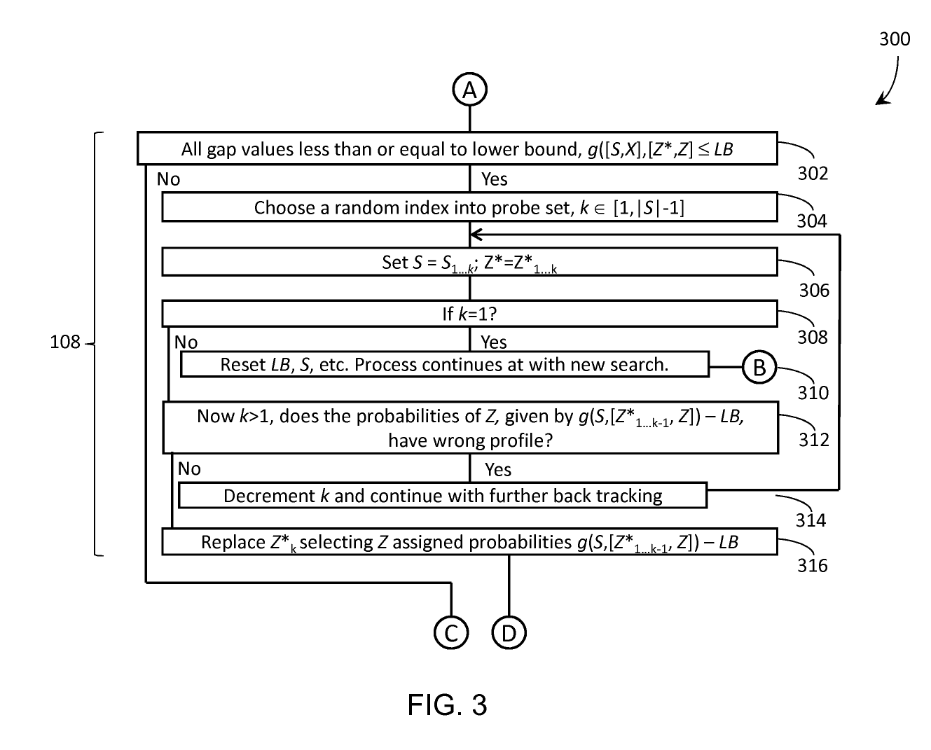

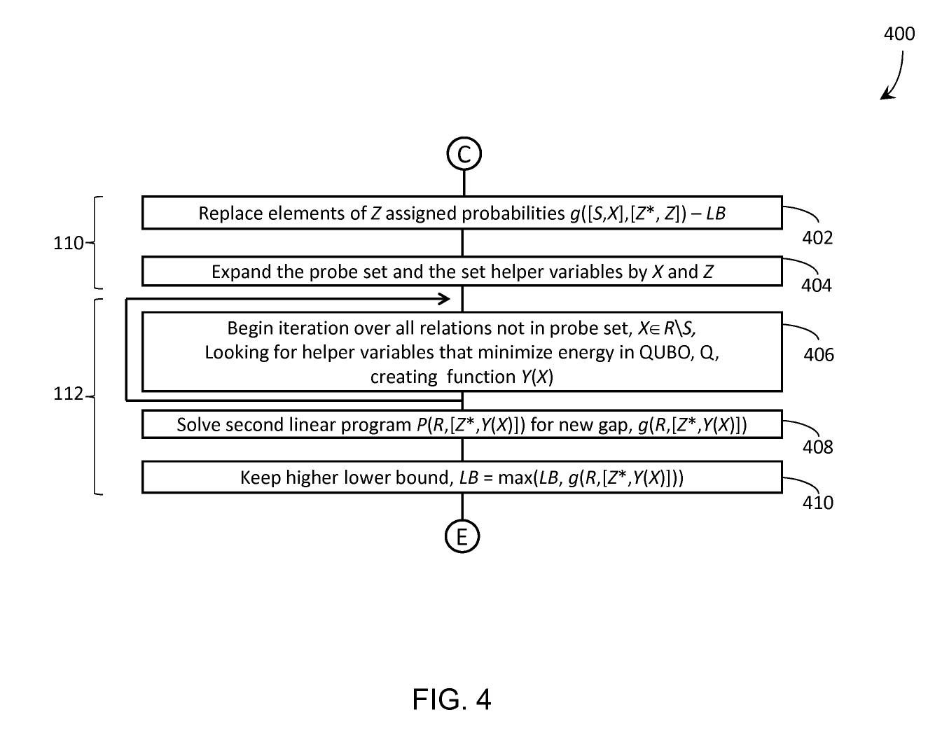

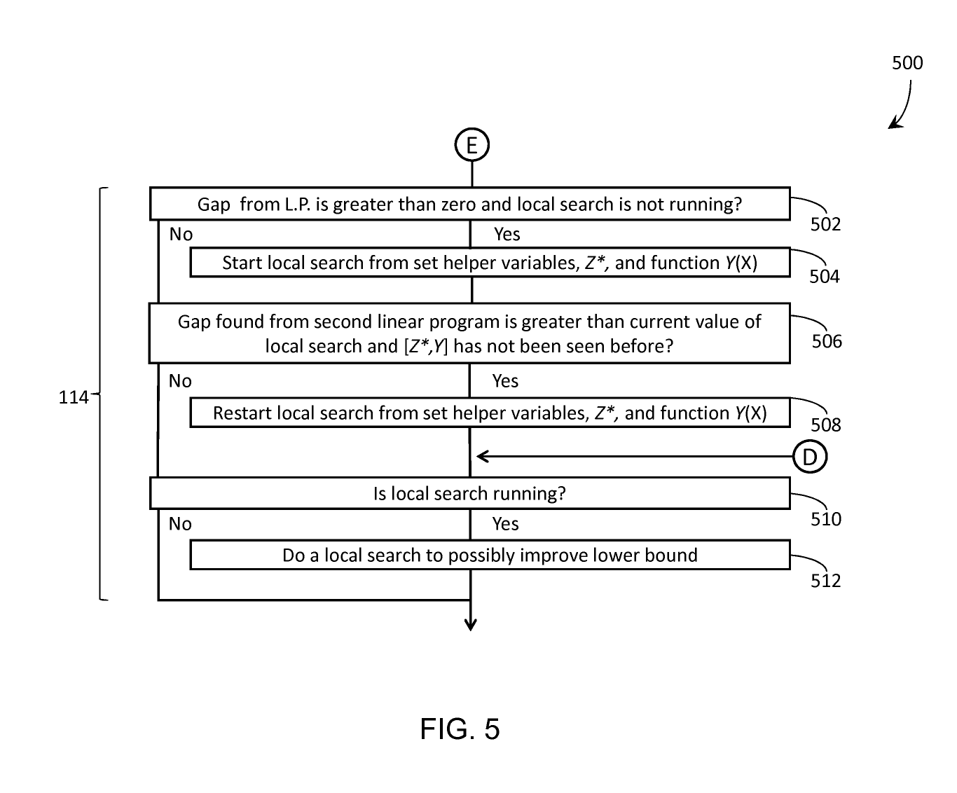

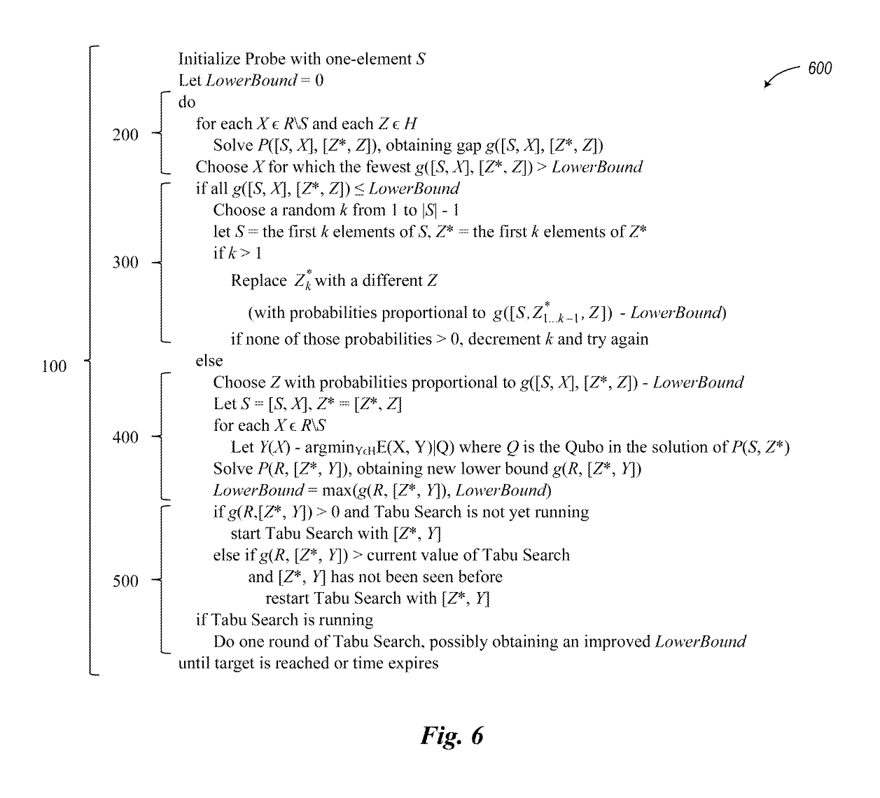

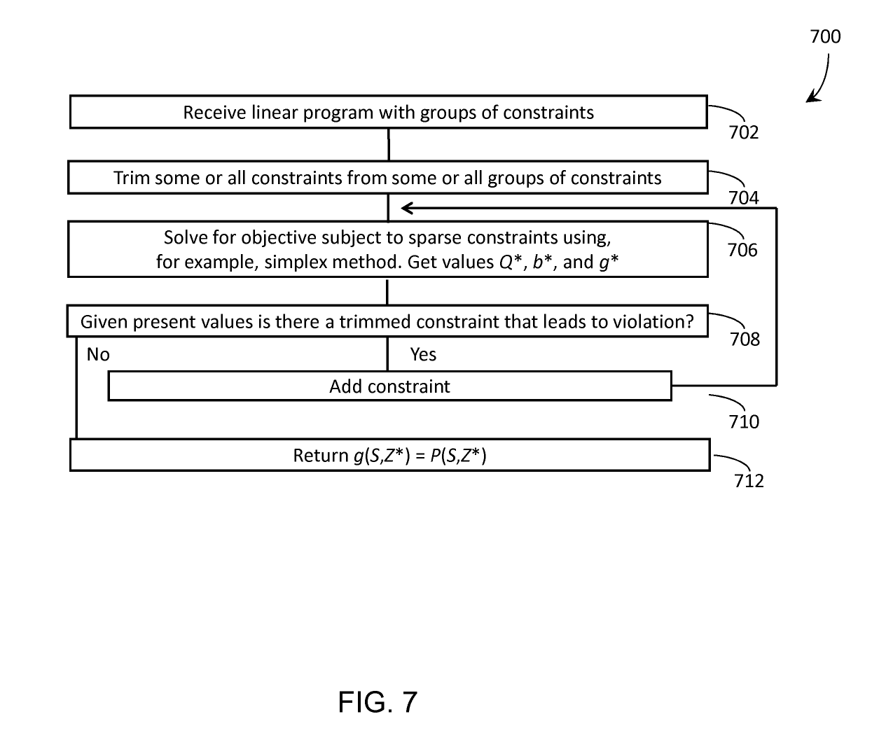

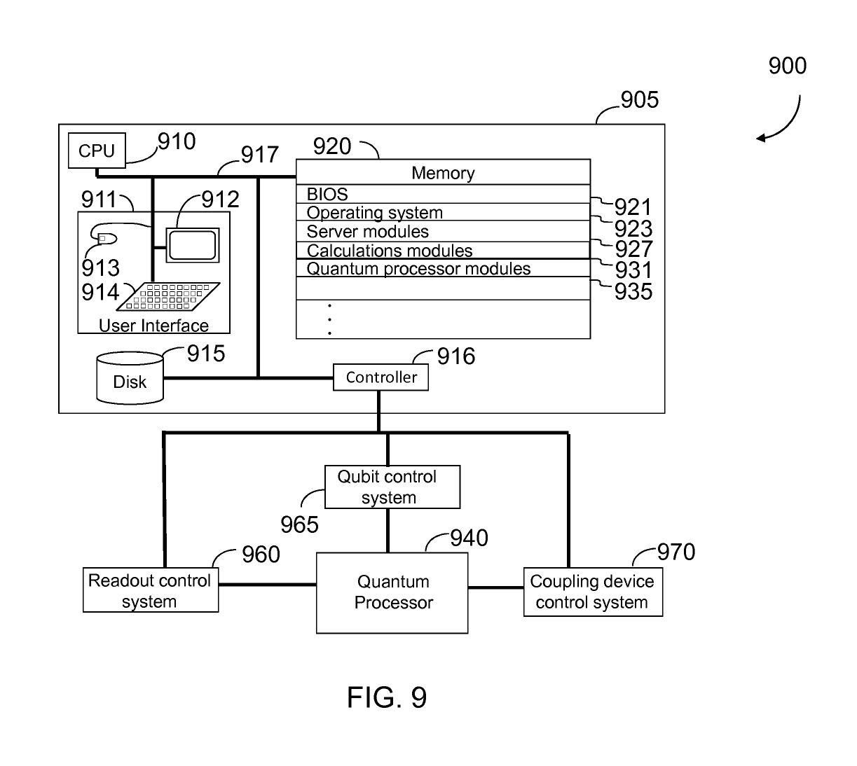

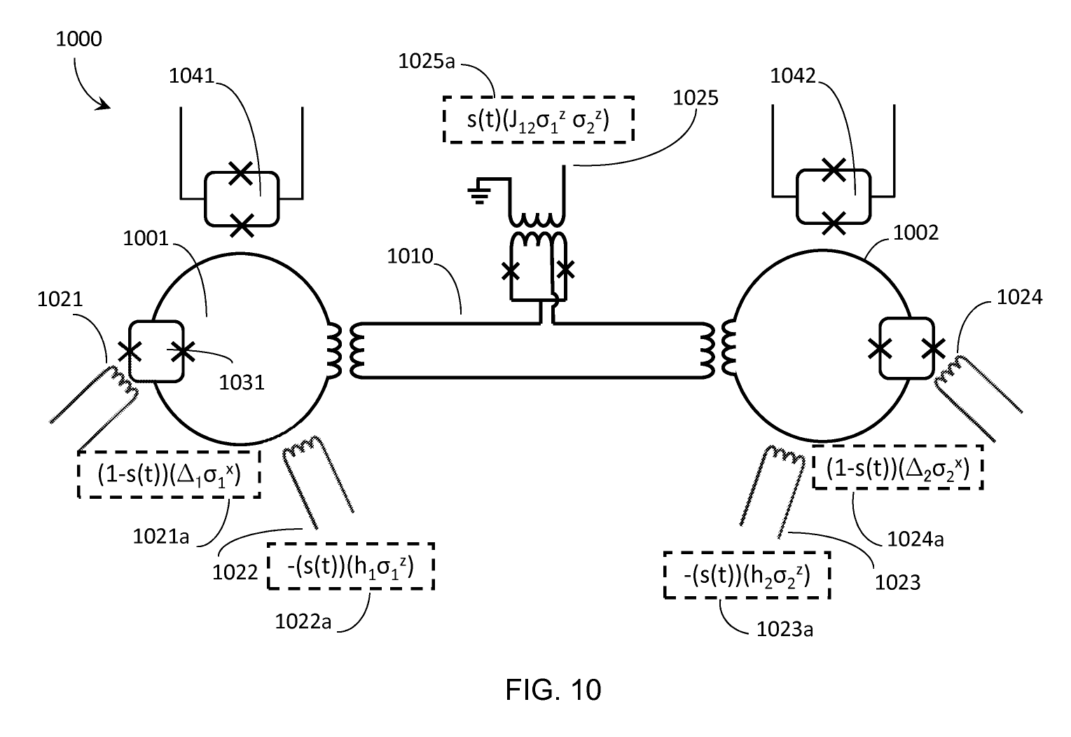

The present techniques relate to finding instances of quadratic binary optimization QUBO problems. In some embodiments, these QUBO problems are used in further techniques to map satisfiability problems and constraint satisfaction problems to optimization problems. For example, a satisfiability problem can be taken broken up into smaller portions that each includes a set of relations. This set of relations can be used to find a QUBO problem (FIG. 1). Alternatively, in some embodiments, a constraint problem is transformed into an optimization problem. A method of searching for QUBO problems and associated gap values is shown in FIG. 2. The search is over the set of relations and a set of helper variables. In FIG. 3 the search result is tested, as needed, backtracking is done. In FIG. 4, a solution from the search is accepted and improved related solutions are sought. Still improved solutions are sought by local searching in FIG. 5. The methods from the preceding figures are shown as pseudocode in FIG. 6. In some embodiments, this process is aided by improved techniques to solve linear programs (FIG. 7). A QUBO problem can be found using a digital computer. A QUBO problem can be solved on a digital computer or a quantum computer. A digital computer coupled to a quantum computer is shown in FIG. 9. A portion of a quantum computer is shown in FIG. 10.

FIG. 1 is a flow-diagram showing a method 100 for finding a QUBO problem in accordance with embodiments of the present invention. In method 100, at 102 set of relations R and a graph G are received. In some embodiments the receipt is by a computer. In some embodiments, the receipt is by a QUBO problem finder. In some embodiments, the set of relations R is expressed as an array of binary values. In some embodiments, the graph G is expressed as an adjacency matrix. At 104 a set of variable are initialized. These variables include probe S, a set of relations, that is expanded in the method 100. These variables include helper variables H whose value is not specified but will be used to construct the QUBO problem. Also set is a lower bound on the value of a gap value. In method 100 and associated methods the value of the gap is of interest. At 106 an iterative portion of the method begins. A search is made over a set of relations and variables to find a lower bound on the maximum gap in a linear program. This search is made of over a tree like structure, for example, a partially ordered set or poset.

After the search, at 108, backtracking is made to consider if a new maximum gap can be determined in a previously searched part of the tree structure. At 110 once a solution has been found, that is the helper variables are set for all the relations in the input set of relations. In addition at 112 good solutions are sought by solving further linear programming problems and/or searches. At 114 a local search can be made to improve on found solutions. Iteration over 106 to 116 continues until a termination condition, as tested by 116, is reached. At 118 a set of values returned by the computer (or QUBO problem finder), including: the best gap found in the method 100, a QUBO problem associated with the best gap, and a set of relations.

The process in method 100 is an example of moving from a constraint focused problem to an optimization focused problem. The optimization problem of interest here is QUBO but a person of ordinary skill in the art will appreciate that a QUBO problem can be mapped to an Ising problem or a Weighted MAX-2-SAT, and vice versa and amongst the group of three classes of problems. Some computing hardware, such as a quantum annealer, and some computational techniques, such that practice energy minimization techniques cannot natively encode constraints. Constraints are dealt with by assigning the disallowed configurations energy penalties. In moving from satisfaction and constraint problems to optimization problems the energy scale of the penalties must be considered. Thus finding a QUBO problem and an associated lower bound on the gap is useful. In some embodiments, helper variables are introduced to enforce the constraints or construct a suitable gap.

FIG. 2 is a flow-diagram showing a method 200 for searching over a tree like structure for a QUBO problem and an associated gap, in accordance with embodiments of the present invention. A set of probe relations S are tested and expanded in method 200. In some embodiments, the search is over a partially ordered set, or poset. At 202 a set of variables is received. These variables include the probe set, S; a set of helper variables, H; a lower bound on the gap, LB; and the like. At 204 an iterative loop begins. The iterative loop 204 is over the relations X in the set of relations R that are not probe set, S. These relations are over the input variables. At 206 a nested iterative loop begins. The nested iterative loop 204 is over the relations Z associated with the helper variables. At 208 a linear program P is solved obtaining a gap and a QUBO problem.

In some embodiments, the linear program P is over the variables X and the helper variables Z. This can have the form:

Maximize: g

Subject to: E(X,Z|Q)≧b∀X∈R,Z∈H

Subject to: E(X,Z|Q)≧b+g∀X∈R^{C},Z∈H

Subject to: E(X,Z*(X)|Q)≦b+g∀X∈S (3)

Where g is a quantity of interest called the gap, R is the set of relations and R^{C} its complement, H is the set of helper variables, E(X,Z|Q) is the energy of the QUBO, Q. That is for a given Q, the energy for configurations of variables and helper variables is:

$$E ( X , Z \vert Q ) = {\sum }_{i \leq j} {{Q}_{ij} ( X , Z )}_{j} \qquad ( 4 )$$

In some embodiments, Q is an upper diagonal matrix where the non-zero elements of Q correspond to edges in the graph G. In some embodiments, the matrix Q is symmetric. The elements on the diagonal can be non-zero. In some embodiments the possible connections between the elements of the graph G are reduced. For example, the graph may be a bipartite graph and one node is connected to at most half the nodes in the graph. In some embodiments, the limitations on these graphs can be overcome by the addition of helper variables.

In solving the linear program P the gap g is determined, as well as the set of variables Z*. The iteration continues over the variables X in R but not in probe, S and over the helper variables, Z. At 210 the configuration of X is selected that gives the fewest helper variables with a gap greater than the lower bound, LB. Note the fewest can be zero. Processing continues is at 302.

FIG. 3 is a flow-diagram showing a method 300 illustrating an example of a portion of the method 100 from FIG. 1, in accordance with embodiments of the present invention. At 302 a plurality of gaps for a given set of variables and helper variables is received, and compared to the current lower bound value, LB. If all of the gaps are not less than or equal to the lower bound, then control passes to 402 for further processing. If all the gaps are less than or equal to the lower bound, then control passes to 402, where backtracking starts. At 304, a random index into the probe set is chosen. That is, select a positive integer, k, between 1 and the number of elements in the probe. In some embodiments, the last member is excluded. At 306, redefine the probe to be the first k elements of probe. Make a similar truncation of the helper variables. At 308, test if the random index equals one. If the random index equals one at 308, then at 310 the lower bound on gap is reset, and processing continues at 106. If the random index does not equal one at 308, then at 312 it is determined whether the profile of the probabilities associated with each helper variable is wrong. That is, assign to each helper variable a probability proportional to g(S,[Z*_{1 . . . k-1},Z])−LB. If the profile is wrong, for example, all the probabilities are less than zero, then control passes to 314. At 314, decrement the index k, and control returns to 306 to continue processing. That is, backtrack further. If it is determined that the profile is not wrong at 312, the profile of the probabilities is acceptable. So control passes to 316 to replace the current helper variable Z*ₖ with a sampled helper variable Z selected from the set of helper variables according the probability assigned to each Z that is proportional to g(S,[Z*_{1 . . . k-1}, Z])−LB.

FIG. 4 is a flow-diagram showing a method 400 illustrating examples of portions of the method 100 from FIG. 1, in accordance with embodiments of the present invention. As noted above, control may pass to 402 in response to a determination at 302 that all of the gaps are not less than or equal to the lower bound At 402, replace the current helper variables by selecting Z with probability that is proportional to g([S,X],[Z*,Z])−LB. That is once X is chosen, in FIG. 2, each corresponding Z is given a probability and randomly chosen according to the probabilities.

At 404, expand the probe by one variable to include the current variable, X, and expand the set of fixed values for the helper variables by one helper variable, Z. That is S=[S,X], Z=[Z*,Z].

In some embodiments, the method 400 may include finding a better solution. For example, at 406, begin an iterative loop over the variables in the relation R and not in the probe set, S. In the iterative loop at 406 let Y(X) be the arguments drawn from the set of helper variables that minimizes the energy of the QUBO that is part of the solution to P(S,Z*). That is, find minimum of E(X,Z|Q) by varying Z and record the value of Z calling it Y(X). This value of the helper variable will prime a linear program.

At 408, solve another linear program to find an improved solution. In some embodiments and unlike in 106 the linear program is over all the relations in the set R and not just the in probe set S. Further, this linear program is over the set of helper variables determined as extended by the helper variable that minimizes the objective function from 406. That is solve P(R,[Z*,Y]) for a new lower bound, g(R,[Z*,Y]).

At 410 compare the newly obtained lower bound, g(R,[Z*,Y]), to the current value of the lower bound, LB and retain the maximum value. Thus the highest value for the lower bound is built up with iteration.

FIG. 5 is a flow-diagram of a method 500 for looking for still improved solutions by a local search in accordance with embodiments of the present invention. At this point good solutions have been found, that is, the helper variables are defined with respect to all relations in the set of relations R, and the gap is positive. The solution may be improved by a locale search procedure.

The method may include examination of local searches include tabu searches, generic algorithms, simulated annealing. Tabu search is a heuristic search technique. The approach includes searching the provided space but avoiding getting trapped by forbidding moves which take the search to points in the solution space previously visited. These are deemed “tabu”. Thus moves that reverse direction or bring the search back to visited location are not entertained. Here the search space is the relations in the set of relations R, and the helper variables, H.

In simulated annealing there is an energy function is to be minimized. The goal is to bring the system, from an initial state, to a state with a low energy. At each step, the method considers some neighboring states of a current state. The method probabilistically decides between moving the system to a neighboring state, or staying in the current state. These are initially such that probabilities of transiting to a higher energy state are possible but ultimately only transitions to lower energy states are contemplated.

Generic algorithms are heuristic search techniques that mimic the process of natural selection. Solutions are bread, evaluated and bread again. In genetic algorithms the starting point of the search is given. A locale search from two points in the solution space may arrive at a different solutions.

At 502, a test is made as to whether the gap determined by solving linear program is greater than zero and a local search is not running. If not, the method continues at 506. If yes, then at 504 the local search is started around the defined helper variables Z* and the function Y. In some embodiments, the local search can change a portion of the defined helper variables Z* up to and including all the bits that correspond to a row in the set of relations R. At 506, it is determined whether the gap found from the linear program is greater than current value of local search and the point in the solution space [Z*,Y] has not been seen before. If so, then processing continues at 508, and if not control passes to 510. At 508, the local search is restarted from [Z*,Y]. The method previous to 510 includes 316 from method 300 and 506. At 510, a determination is made as to whether the local search is running. The local search can be run in parallel to the method 100. If the local search is running, control passes to 512 where a round of a local search is made to improve the lower bound. Control then passes to 116 (FIG. 1) where processing continues. If it is determined at 510 that the local search is no running, control passes directly to 116 (FIG. 1), with performing the round of local search at 512.

FIG. 6 is a block of pseudocode for executing the methods of the flow diagrams in the preceding figures in accordance with embodiments of the present invention. The pseudocode provides a more compact description of the methods disclosed. However, not all embodiments of the methods are illustrated by block 600. For example, missing from method 100 is the returned values and shown in method 500 the local search is a tabu search and not a genetic algorithm or simulated annealing. In some embodiments of the method 100 there are two different linear programs that are solved. For example, in method 200 the finding of the gap in the search over the relations and helper variables includes a linear program. In some embodiments, the solving of the linear program involves delayed constraint generation.

FIG. 7 is a flow-diagram for a method 700 to implement a form of delayed constraint generation in accordance with embodiments of the present invention. At 702, a linear program with groups of constraints is received. An example of a linear program is provided in method 400 at 408. Solving a linear program involves finding an optimal solution of a linear objective function subject to linear constraints expressed as equalities and inequalities. These constraints can be divided into groups for example, a group for equality and a group for inequalities. Alternatively or additionally, there can, for example, be a group for variables and a group for helper variables.

At 704, the constraints in the groups of constraints are trimmed. In some embodiments at least one constraint is trimmed from each group of constraints. In some embodiments, the constraints for trimming are found in one or more groups of constraints but one or more groups of constraints are left intact. For example, in the set of Equations (3) the one or more constraints are left in the first to groups of constraints all the constraints are left in third group, E(X,Z*(X)|Q)≦b+g.

At 706, the linear program is solved. In some embodiments a simplex method is used. In some embodiment the CPLEX technique may be used. The IBM ILOG CPLEX Optimization Studio, is available from International Business Machines Corp., of Armonk, N.Y., US. Other implementations are found with or implemented in other mathematical software such as Maple, computer algebra systems, by Waterloo Maple Inc. of Waterloo, ON, Canada, and Matlab, numerical computing environment, by Mathworks of Natick, Mass., US. At 708, the instant values of the solution are used to see if any previously trimmed constraint can be found that violated by the instant values. If there is a trimmed constraint that leads to violation, the constraint that is violated is added at 710, and control returns to 706 to solve the linear program again. If there is not a trimmed constraint that leads to violation, then control passes to 712, where a solution to the linear program has been found at the present values and can be returned. In some embodiments the number of constraints generated and uses is kept constraint. As new constraints are needed constraints are discarded. The older, meaning the last time it was found to be binding in the linear programming solver, the constraint the more likely the constraint is to be discarded.

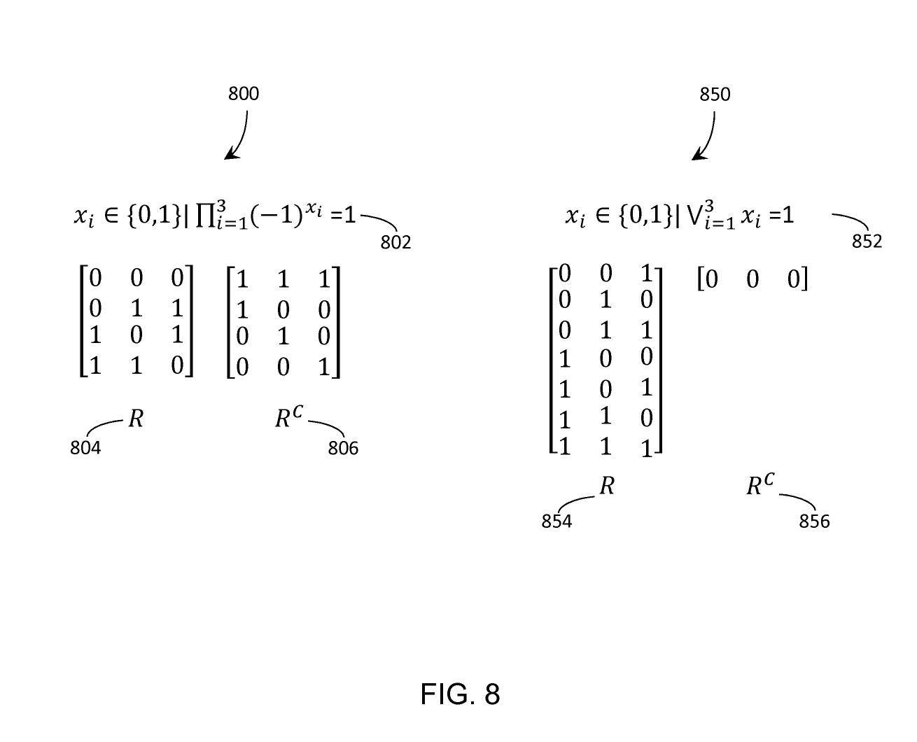

FIG. 8 shows to examples of constraints, the associated relations, and the complement to the relations in accordance with embodiments of the present invention. At 800 is an illustration of constraints, the associated relations, and the complement to the relations A constraint on a set of binary variables is show at equation 802. The parity of the variables must be even. The relations associated with that constrain are shown in set of relations R in matrix 804. Note each row is of even parity. The complements to the relations are shown in set of relations R^{C} in matrix 806. Note each row is of odd parity.

At 850 is an illustration of constraints associated with a satisfaction problem, the associated relations, and the complement to the relations A constraint on a set of binary variables is show at equation 852. The disjunction of variables must evaluate to unity or true. The relations associated with that constrain are shown in set of relations R in matrix 854. The complements to the relations are shown in set of relations R^{C} in matrix 856. Note how there is only one disallowed configuration. These examples can be used in methods described herein.

FIG. 9 illustrates computing system 900 including a digital computer 901 coupled to a quantum computer 951. Shown is an exemplary digital computer 901 including a digital processor that may be used to perform classical digital processing tasks described in the present systems and methods. Those skilled in the relevant art will appreciate that the present systems and methods can be practiced with other digital computer configurations, including hand-held devices, multiprocessor systems, microprocessor-based or programmable consumer electronics, personal computers (“PCs”), network PCs, mini-computers, mainframe computers, and the like. Digital computer 901 will at times be referred to in the singular herein, but this is not intended to limit the application to a single digital computer. The present systems and methods can also be practiced in distributed computing environments, where tasks or modules are performed by remote processing devices, which are linked through a communications network. In a distributed computing environment, program modules may be located in both local and remote memory storage devices.

Digital computer 901 may include at least one processing unit (such as, central processor unit 910), at least one system memory 920, and at least one system bus 917 that couples various system components, including system memory 920 to central processor unit 910.

The digital processor may be any logic processing unit, such as one or more central processing units (“CPUs”), digital signal processors (“DSPs”), application-specific integrated circuits (“ASICs”), etc. Unless described otherwise, the construction and operation of the various blocks shown in FIG. 9 are of conventional design. As a result, such blocks need not be described in further detail herein, as they will be understood by those skilled in the relevant art.

System bus 917 can employ any known bus structures or architectures, including a memory bus with a memory controller, a peripheral bus, and a local bus. System memory 920 may include non-volatile memory such as read-only memory (“ROM”) and volatile memory such as random access memory (“RAM”) (not shown). An basic input/output system (“BIOS”) 921, which can form part of the ROM, contains basic routines that help transfer information between elements within digital computer 901, such as during startup.

Digital computer 901 may also include other non-volatile memory 915. Non-volatile memory 915 may take a variety of forms, including: a hard disk drive for reading from and writing to a hard disk, an optical disk drive for reading from and writing to removable optical disks, and/or a magnetic disk drive for reading from and writing to magnetic disks. The optical disk can be a CD-ROM or DVD, while the magnetic disk can be a magnetic floppy disk or diskette. Non-volatile memory 915 may communicate with digital processor via system bus 917 and may include appropriate interfaces or controllers 916 coupled to system bus 916. Non-volatile memory 915 may serve as long-term storage for computer-readable instructions, data structures, program modules and other data for digital computer 901. Although digital computer 901 has been described as employing hard disks, optical disks and/or magnetic disks, those skilled in the relevant art will appreciate that other types of non-volatile computer-readable media may be employed, such a magnetic cassettes, flash memory cards, Bernoulli cartridges, Flash, ROMs, smart cards, etc.

Various program modules, application programs and/or data can be stored in system memory 920. For example, system memory 920 may store an operating system 923, and server modules 927. In some embodiments, server module 927 includes instruction for communicating with remote clients and scheduling use of resources including resources on the digital computer 901 and quantum computer 951. For example, a Web server application and/or Web client or browser application for permitting digital computer 901 to exchange data with sources via the Internet, corporate Intranets, or other networks, as well as with other server applications executing on server computers.

In some embodiments system memory 920 may store a calculation module 931 to perform pre-processing, co-processing, and post-processing to quantum computer 951. In accordance with the present systems and methods, system memory 920 may store at set of quantum computer interface modules 935 operable to interact with a quantum computer 951. While shown in FIG. 9 as being stored in system memory 920, the modules shown and other data can also be stored elsewhere including in nonvolatile memory 915.

The quantum computer 951 is provided in an isolated environment (not shown) to shield the internal elements of the quantum computer from heat, magnetic field, and the like. The quantum computer includes a quantum processor 940 including qubits having programmable topology as discussed herein. Examples of qubits are discussed below. The qubits are readout via readout out system 960. These results are fed to the various modules in the digital computer 901 including server modules 927, calculation module 931, or quantum computer interface modules 935, stored in nonvolatile memory 915, returned over a network or the like. The qubits are controlled via qubit control system 965. The couplers are controlled via coupler control system 970. In some embodiments of the qubit control system 965 and the coupler control system 970 are used to implement quantum annealing as described herein on quantum processor 940.

In some embodiments the digital computer 901 can operate in a networking environment using logical connections to at least one client computer system. In some embodiments the digital computer 901 is coupled via logical connections to at least one database system. These logical connections may be formed using any means of digital communication, for example, through a network, such as a local area network (“LAN”) or a wide area network (“WAN”) including, for example, the Internet. The networking environment may include wired or wireless enterprise-wide computer networks, intranets, extranets, and/or the Internet. Other embodiments may include other types of communication networks such as telecommunications networks, cellular networks, paging networks, and other mobile networks. The information sent or received via the logical connections may or may not be encrypted. When used in a LAN networking environment, digital computer 901 may be connected to the LAN through an adapter or network interface card (“NIC”) (communicatively linked to bus 917). When used in a WAN networking environment, digital computer 901 may include an interface and modem (not shown), or a device such as NIC, for establishing communications over the WAN. Non-networked communications may additionally, or alternatively be employed.

In accordance with some embodiments of the present systems and devices, a quantum processor may be designed to perform adiabatic quantum computation and/or quantum annealing. An evolution Hamiltonian is proportional to the sum of a first term proportional to the problem Hamiltonian and a second term proportional to the disordering Hamiltonian. As previously discussed, a typical evolution may be represented by Equation (5):

H_{E}∝A(t)H_{D}+B(t)H_{P} (5)

where H_{P} is the problem Hamiltonian, disordering Hamiltonian is H_{D}, H_{E} is the evolution or instantaneous Hamiltonian, and A(t) and B(t) are examples of an evolution coefficient which controls the rate of evolution. In general, evolution coefficients vary from 0 to 1. In some embodiments, a time varying evolution coefficient is placed on the problem Hamiltonian. A common disordering Hamiltonian is shown in Equation (6):

$${H}_{D} ∝ - \frac{1}{2} {\sum }_{i = 1}^{N} {Δ}_{i} {σ}_{i}^{x} \qquad ( 6 )$$

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms. A common problem Hamiltonian includes first component proportional to diagonal single qubit terms and a second component proportional to diagonal multi-qubit terms. The problem Hamiltonian, for example, may be of the form:

$${H}_{P} ∝ - \frac{ɛ}{2} [ {\sum }_{i = 1}^{N} {h}_{i} {σ}_{i}^{z} + {{\sum }_{j > i}}^{N} {J}_{ij} {σ}_{i}^{z} {σ}_{j}^{z} ] \qquad ( 7 )$$

where N represents the number of qubits, σᵢ^{z} is the Pauli z-matrix for the i^{th} qubit, hᵢ and J_{i,j} are dimensionless local fields coupled into each qubit, and ε is some characteristic energy scale for H_{P}. Here, the σᵢ^{z} and σᵢ^{z}σⱼ^{z} terms are examples of “diagonal” terms. The former is a single qubit term and the latter a two qubit term. Throughout this specification, the terms “problem Hamiltonian” and “final Hamiltonian” are used interchangeably. Hamiltonians such as H_{D} and H_{P} in Equations (6) and (7), respectively, may be physically realized in a variety of different ways. A particular example is realized by an implementation of superconducting qubits.

FIG. 10 is a schematic diagram of a portion of an exemplary superconducting quantum processor 1000 designed for quantum annealing (and/or adiabatic quantum computing) components from which may be used to implement the present systems and devices. The portion of superconducting quantum processor 100 shown in FIG. 10 includes two superconducting qubits 1001, and 1002. Also shown is a tunable ZZ-coupling (diagonal coupling) 1010 therebetween qubits 1001 and 1002 (i.e., providing 2-local interaction). While the portion of quantum processor 1000 shown in FIG. 10 includes only two qubits 1001, 1002 and one coupler 1010, those of skill in the art will appreciate that quantum processor 1000 may include any number of qubits and any number of coupling devices coupling information therebetween.

The portion of quantum processor 1000 shown in FIG. 10 may be implemented to physically realize adiabatic quantum computing and/or quantum annealing. Quantum processor 1000 includes a plurality of interfaces 1021-1025 that are used to configure and control the state of quantum processor 1000. Each of interfaces 1021-1025 may be realized by a respective inductive coupling structure, as illustrated, as part of a programming subsystem and/or an evolution subsystem. Such a programming subsystem and/or evolution subsystem may be separate from quantum processor 1000, or it may be included locally (i.e., on-chip with quantum processor 1000) as described in, for example, U.S. Pat. No. 7,876,248 and U.S. Pat. No. 8,035,540.

In the operation of quantum processor 1000, interfaces 1021 and 1024 may each be used to couple a flux signal into a respective compound Josephson junction 1031 and 1032 of qubits 1001 and 1002, thereby realizing the Δᵢ terms in the system Hamiltonian. This coupling provides the off-diagonal σ^{x} terms of the Hamiltonian described by Equation (6) and these flux signals are examples of “disordering signals.” Similarly, interfaces 1022 and 1023 may each be used to apply a flux signal into a respective qubit loop of qubits 1001 and 1002, thereby realizing the hᵢ terms in the system Hamiltonian. This coupling provides the diagonal σ^{z} terms of Equation (7). Furthermore, interface 1025 may be used to couple a flux signal into coupler 1010, thereby realizing the Jᵢⱼ term(s) in the system Hamiltonian. This coupling provides the diagonal σ^{z}ᵢσ^{z}ⱼ terms of Equation (7). In FIG. 10, the contribution of each of interfaces 1021-1025 to the system Hamiltonian is indicated in boxes 1021a-1025a, respectively. As shown, in the example of FIG. 10, the boxes 1021a-1025a are elements of time varying Hamiltonian for adiabatic quantum computing and/or quantum annealing.

Throughout this specification and the appended claims, the term “quantum processor” is used to generally describe a collection of physical qubits (e.g., qubits 1001 and 1002) and couplers (e.g., coupler 1010). The physical qubits 1001 and 1002 and the couplers 1010 are referred to as the “programmable elements” of the quantum processor 100 and their corresponding parameters (e.g., the qubit hᵢ values and the coupler Jᵢⱼ values) are referred to as the “programmable parameters” of the quantum processor. In the context of a quantum processor, the term “programming subsystem” is used to generally describe the interfaces (e.g., “programming interfaces” 1022, 1023, and 1025) used to apply the programmable parameters (e.g., the hᵢ and Jᵢⱼ terms) to the programmable elements of the quantum processor 1000 and other associated control circuitry and/or instructions. As previously described, the programming interfaces of the programming subsystem may communicate with other subsystems which may be separate from the quantum processor or may be included locally on the processor. As described in more detail later, the programming subsystem may be configured to receive programming instructions in a machine language of the quantum processor and execute the programming instructions to program the programmable elements in accordance with the programming instructions. Similarly, in the context of a quantum processor, the term “evolution subsystem” is used to generally describe the interfaces (e.g., “evolution interfaces” 1021 and 1024) used to evolve the programmable elements of the quantum processor 1000 and other associated control circuitry and/or instructions. For example, the evolution subsystem may include annealing signal lines and their corresponding interfaces (1021, 1024) to the qubits (1001, 1002).

Quantum processor 100 also includes readout devices 1051 and 1052, where readout device 1051 is associated with qubit 1001 and readout device 1042 is associated with qubit 1002. In the embodiment shown in FIG. 10, each of readout devices 1051 and 1052 includes a DC-SQUID inductively coupled to the corresponding qubit. In the context of quantum processor 1000, the term “readout subsystem” is used to generally describe the readout devices 1051, 1052 used to read out the final states of the qubits (e.g., qubits 1001 and 1002) in the quantum processor to produce a bit string. The readout subsystem may also include other elements, such as routing circuitry (e.g., latching elements, a shift register, or a multiplexer circuit) and/or may be arranged in alternative configurations (e.g., an XY-addressable array, an XYZ-addressable array, etc.). Qubit readout may also be performed using alternative circuits, such as that described in PCT Patent Publication No. WO2012/064974.

While FIG. 10 illustrates only two physical qubits 1001, 1002, one coupler 1010, and two readout devices 1051, 1052, a quantum processor (e.g., processor 1000) may employ any number of qubits, couplers, and/or readout devices, including a larger number (e.g., hundreds, thousands or more) of qubits, couplers and/or readout devices. The application of the teachings herein to processors with a different (e.g., larger) number of computational components should be readily apparent to those of ordinary skill in the art.

Examples of superconducting qubits include superconducting flux qubits, superconducting charge qubits, and the like. In flux qubit the Josephson energy dominates or is equal to the charging energy. In a charge qubit it is the reverse. Examples of flux qubits that may be used include rf-SQUIDs, which include a superconducting loop interrupted by one Josephson junction, persistent current qubits, which include a superconducting loop interrupted by three Josephson junctions, and the like. See, examples of rf-SQUID qubits in Bocko, et al., 1997 IEEE Trans. on Appl. Supercond. 7, 3638; Friedman, et al., 2000, Nature 406, 43; and Harris, et al., 2010, Phys. Rev. B 81, 134510; or persistent current qubits, Mooij et al., 1999, Science 285, 1036; and Orlando et al., 1999, Phys. Rev. B 60, 15398. In addition, hybrid charge-phase qubits, where the energies are equal, may also be used. Further details of superconducting qubits may be found in Makhlin, et al., 2001, Rev. Mod. Phys. 73, 357; Devoret et al., 2004, arXiv:cond-mat/0411174; Zagoskin and Blais, 2007, Physics in Canada 63, 215; Clarke and Wilhelm, 2008, Nature 453, 1031; Martinis, 2009, Quantum Inf. Process. 8, 81; and Devoret and Schoelkopf, 2013, Science 339, 1169. In some embodiments, the qubit is controlled by on chip circuitry. Examples of on-chip control circuitry can be found in U.S. Pat. Nos. 7,876,248; 7,843,209; 8,018,244; 8,098,179; 8,169,231; and U.S. Patent Publication 2012-0094838.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other methods of quantum computation, not necessarily the exemplary methods for quantum computation generally described above.

The various embodiments described above can be combined to provide further embodiments. To the extent that they are not inconsistent with the specific teachings and definitions herein, all of the U.S. patents, U.S. patent application publications, U.S. patent applications, referred to in this specification and/or listed in the Application Data Sheet are incorporated herein by reference, including but not limited to U.S. Provisional Patent Application No. 61/906,220, filed Nov. 19, 2013 and U.S. Provisional Patent Application No. 61/977,458, filed Apr. 9, 2014 which are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of problem solving on one or more processors, the method comprising:
receiving a relation and a graph;
initializing a probe set;
initializing a lower bound;
for a number of cycles until an end condition is reached:
iterating over an expansion of the probe set and a configuration of helper variables to solve a first linear program for a quadratic unconstrained binary optimization (QUBO) problem and an energy gap which corresponds to the QUBO problem;
selecting an expanded probe set with a sufficiently small number of solutions for which the energy gap exceeds the lower bound;
determining whether there are no solutions for which the energy gap exceeds the lower bound,
in response to determining that there are no solutions for which the energy gap exceeds the lower bound, backtracking in the probe set;
selecting a respective configuration of helper variables at random based on a probability proportional to a difference between the energy gap and the lower bound;
solving a second linear program to determine a first new lower bound;
in response to the first new lower bound exceeding the lower bound, setting the lower bound equal to the first new lower bound;
performing a local search to determine a second new lower bound; and
in response to the second new lower bound exceeding the lower bound, setting the lower bound equal to the second new lower bound.

2. The method of claim 1, further comprising:
repeating the iterating, selecting, determining, backtracking, selecting, solving, setting and performing until the end condition of an earliest of: the lower bound exceeds a determined threshold, a defined time has elapsed, or a defined number of cycles has been performed.

3. A system to solve problems, the system comprising:
at least one processor; and
at least one nontransitory processor-readable medium communicatively coupled to the at least one processor and which stores at least one of processor-executable instructions or data, which when executed by the at least one processor causes the at least one processor to:
initialize a probe set;
initialize a lower bound;
for a number of cycles until an end condition is reached:
iterate over an expansion of the probe set and a configuration of helper variables to solve a first linear program for a quadratic unconstrained binary optimization (QUBO) problem and an energy gap which corresponds to the QUBO problem;
select an expanded probe set with a sufficiently small number of solutions for which the energy gap exceeds the lower bound;
determine whether there are no solutions for which the energy gap exceeds the lower bound,
in response to a determination that there are no solutions for which the energy gap exceeds the lower bound, backtrack in the probe set;
select a respective configuration of helper variables at random based on a probability proportional to a difference between the energy gap and the lower bound;
solve a second linear program to determine a first new lower bound;
in response to the first new lower bound exceeding the lower bond, set the lower bound equal to the first new lower bound;
perform a local search to determine a second new lower bound; and
in response to the second new lower bound exceeding the lower bound, set the lower bound equal to the second new lower bound.

4. The system of claim 1 wherein the at least one processor repeats the cycles until end condition of an earliest of: the lower bound exceeds a determined threshold, a defined time has elapsed, or a defined number of cycles has been performed.

5. A method of solving problems using one or more processors, the method as described and shown in the specification and drawings.

6. A system to solve problems, the system as described and shown in the specification and drawings.
